(19) United States
(12) Patent Application Publication
(10) Pub. No.: US 2015/0339539 A1
(43) Pub. Date: Nov. 26, 2015

(54) METHOD AND SYSTEM FOR DETERMINING CONCENTRATION LEVEL OF A VIEWER OF DISPLAYED CONTENT

(71) Applicants: Xiaodong GU, Beijing (CN); Zhenglong LI, Beijing (CN); Xiaojun MA, Beijing (CN)

(72) Inventors: Xiao Dong Gu, Beijing (CN); Zhenglong Li, Beijing (CN); Xioajun Ma, Beijing (CN)

(21) Appl. No.: 14/655,062

(22) PCT Filed: Dec. 31, 2012
(86) PCT No.: PCT/CN2012/087989

§ 371 Date: Jun. 24, 2015

(51) Int. Cl. G06K 9/46; G06F 3/01

(52) U.S. Cl. CPC G06K 9/46; G06F 3/013

(57) ABSTRACT

There are provided a system and method for determining concentration level of a viewer by modeling an extent to which the viewer is at least one of engaged by and interested in displayed video content. The system includes a view status detector for extracting at least one viewer status feature with respect to the displayed video content, a content analyzer for extracting at least one content characteristic feature with respect to the displayed video content, and a feature comparer for comparing the viewer status and content characteristic features as a feature pair, to produce an estimate of a concentration level associated with the feature pair. The system additionally includes a combiner for combining concentration levels for different feature pairs into an overall concentration level of the viewer for the displayed content.

### TECHNICAL FIELD

The present principles relate generally to video content and, more particularly, to a concentration model for the identification of accurately targeted content.

### BACKGROUND

In recent years, the amount of videos on the Internet has increased tremendously. Thus, it would be beneficial to provide incentive services such as personalized video recommendations and online video content association (VCA). In particular, VCA refers to a service that associates additional materials (e.g., texts, images, and video clips) with the video content (e.g., that a viewer is currently viewing) to enrich the viewing experience. However, conventional personalized video recommendations and VCAs do not consider all relevant factors in providing their services and, thus, operate with deficiencies.

### SUMMARY

These and other drawbacks and disadvantages of the prior art are addressed by the present principles, which are directed to a multi-view three-dimensional display system and method with position sensing and an adaptive number of views.

One aspect of the present principles provides a system for determining concentration level of a viewer of displayed video content. The system includes a view status detector for extracting at least one feature that represents a viewer status with respect to the displayed video content; a content analyzer for extracting at least one feature that represents a content characteristic of the displayed video content; a feature comparer for comparing the viewer status and the content characteristic features as a feature pair, to provide an estimate of a concentration level for the feature pair; and a combiner for combining concentration level estimates for different feature pairs into an overall concentration level.

Another aspect of the present principles provides a method determining concentration level of a viewer of displayed video content. The method includes extracting at least one feature that represents a viewer status with respect to the displayed video content; extracting at least one feature that represents a content characteristic of the displayed video content; comparing the viewer status and content characteristic features as a feature pair to provide an estimate of a concentration level for the feature pair; and combining concentration level estimates for different feature pairs into an overall concentration level.

Yet another aspect of the present principles provides a computer readable storage medium including a computer readable program determining concentration level of a viewer of displayed video content, wherein the computer readable program when executed on a computer causes the computer to perform the following steps: extracting at least one feature that represents a viewer status with respect to the displayed video content; extracting at least one feature that represents a content characteristic of the displayed video content; comparing the viewer status and content characteristic features as a feature pair using a particular comparison method, to provide an estimate of a concentration level for the feature pair; and combining concentration level estimates for different feature pairs into an overall concentration level.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a diagram showing an exemplary processing system to which the present principles can be applied, in accordance with an embodiment of the present principles;

FIG. 2 is a diagram showing an exemplary system for determining concentration level of a viewer with respect to displayed video content, in accordance with an embodiment of the present principles; and

FIG. 3 is a diagram showing an exemplary method for determining concentration level of a viewer with respect to displayed video content, in accordance with an embodiment of the present principles.

### DETAILED DESCRIPTION

The present principles are directed to a concentration model for the identification of accurately targeted content. In an embodiment, the concentration model measures to what extent a viewer is engaged by and/or otherwise interested in currently displayed content, and a concentration level of the viewer is obtained based on a correlation determined between the currently displayed content and the viewer status.

A good video content association (VCA) service should be: (1) non-intrusive, i.e., the associated materials should not interrupt, clutter, or delay the viewing experience; (2) content-related, i.e., the associated materials should be relevant to the video content; and (3) user-targeted, i.e., the associated materials should match the individual preferences of different users.

However, existing studies on VCA indicate a focus on the first two requirements, but not on the third requirement. In particular, the studies show that conventional VCAs do not consider the individual preferences of each user, which is important in order to provide satisfactory VCA services.

From the perspective of intrusiveness, people often show a high tolerance to the associated materials that include content that the user happens to prefer. However, user preference is constantly changing due to the user's mood, surroundings, and so forth. For example, a viewer may generally enjoy a sports video but would not like to have a sport video recommended at a specific time (for one reason or another). Therefore, information about the extent to which a viewer is engaged with and/or otherwise interested in currently displayed content is important to VCA operations.

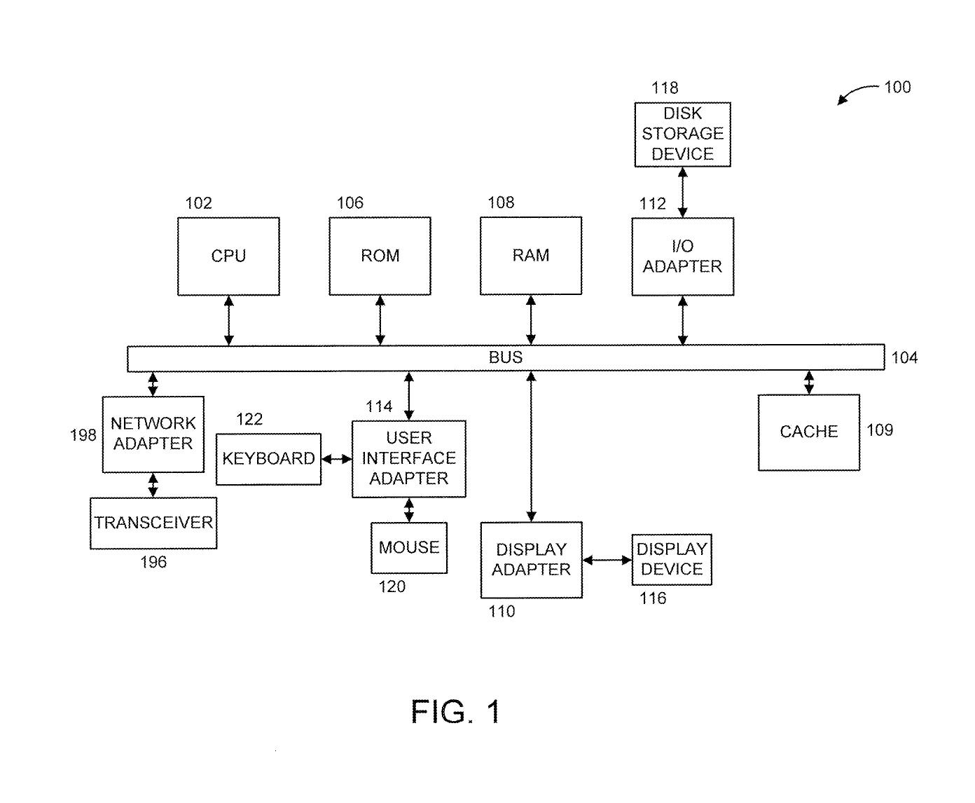

FIG. 1 shows an exemplary processing system 100 to which the present principles may be applied, in accordance with an embodiment of the present principles. The processing system 100 includes at least one processor (CPU) 102 operatively coupled to other components via a system bus 104. A read only memory (ROM) 106, a random access memory (RAM) 108, a display adapter 110, an input/output (I/O) adapter 112, a user interface adapter 114, and a network adapter 198, are operatively coupled to the system bus 104.

A display device 116 is operatively coupled to system bus 104 by display adapter 110. A disk storage device (e.g., a magnetic or optical disk storage device) 118 is operatively coupled to system bus 104 by I/O adapter 112.

A mouse 120 and keyboard 122 are operatively coupled to system bus 104 by user interface adapter 114. The mouse 120 and keyboard 122 are used to input and output information to and from system 100.

A transceiver 196 is operatively coupled to system bus 104 by network adapter 198.

The processing system 100 may also include other elements (not shown), omit certain elements, as well as other variations that are contemplated by one of ordinary skill in the art given the teachings of the present principles provided herein.

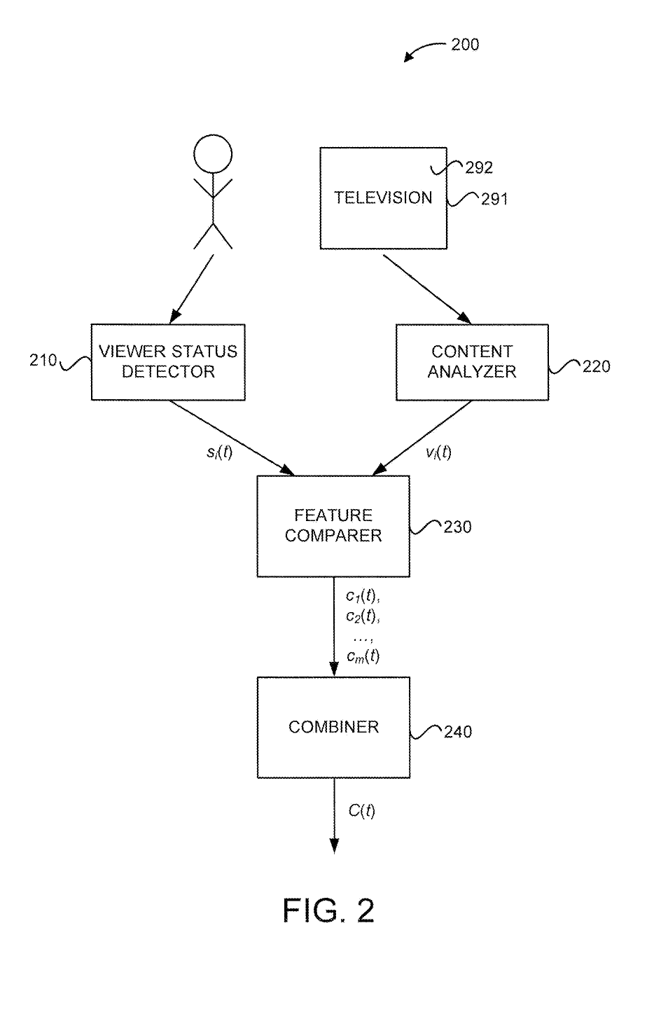

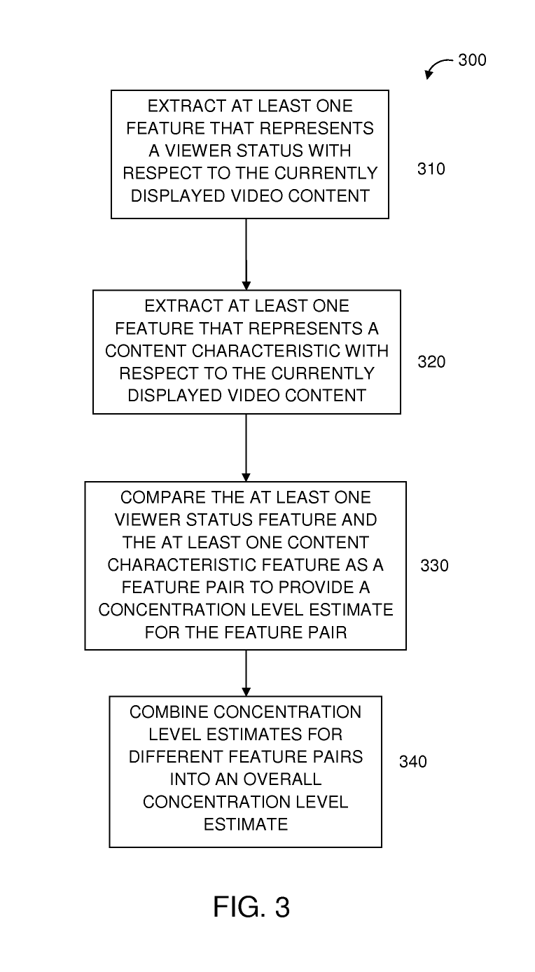

Moreover, it is to be appreciated that system 200 described below with respect to FIG. 2 is a system for implementing respective embodiments of the present principles. Part or all of processing system 100 may be implemented in one or more of the elements of system 200, and part or all of processing system 100 and system 200 may perform at least some of the method steps described herein including, for example, method 300 of FIG. 3.

FIG. 2 shows an exemplary system 200 for determining a concentration level of a viewer of displayed video content, by modeling an extent to which the viewer is engaged by and/or otherwise interested in currently displayed video content, in accordance with an embodiment of the present principles. The system 200 includes a view status detector (VSD) 210, a content analyzer (CA) 220, a feature comparer (FC) 230, and a combiner 240. The system 200 is used with respect to a viewer 291 and a television 292 having content 293 displayed thereon.

The viewer status detector 210 extracts one or more features sᵢ(t) that represent the viewer status, also referred to as viewer status features. The content analyzer 220 extracts one or more features vᵢ(t) that represent the content characteristics, also referred to as content characteristic or video content features. In this representation, subscript “i” is an index for denoting separate features relating to the viewer status or content characteristics, and variable “t” denotes the time corresponding the particular feature (e.g., time at which the displayed content has the specific content characteristic, and the viewer showing the corresponding viewer status). Thus, sᵢ(t) represents a given viewer status feature at time t, and vᵢ(t) represents a corresponding content characteristic at time t.

The feature comparer 230 compares the viewer status and content characteristic features by a particular, or suitable comparison method, represented by a function fᵢ, which results in an estimate of a concentration level cᵢ(t)=fᵢ(sᵢ(t), vᵢ(t)) based on the feature pair: sᵢ(t) and vᵢ(t). When more than one feature pair is selected (e.g., two features pairs: {sᵢ(t), vᵢ(t)}; and {sⱼ(t), vⱼ(t)}, where i≠j) the combiner 240 combines the concentration level estimates for different feature pairs into an overall, more accurate estimate of the concentration level.

The viewer status features sᵢ(t) can be extracted or determined using one or more sensors and/or other devices, or having the viewer directly provide his or her status (e.g., via a user input device), and so forth.

The content characteristic features vᵢ(t) can be extracted or determined using one or more sensors and/or other devices from the content itself or from another source. For example, the actual physical source of the content (e.g., a content repository or content server) may have information categorizing the content available at the source. Moreover, information regarding the content characteristics can be obtained from any relevant source, including an electronic programming guide (EPG), and so forth. It is to be appreciated that the preceding examples of determining the viewer status or content characteristics are merely illustrative and not exhaustive.

In an embodiment, the comparison method used by the feature comparer 230 can vary depending upon the features to be compared. That is, the particular comparison method used for a respective feature pair can be selected (from among multiple comparison methods) responsive to the features that are included in that respective pair, such that at least two different feature pairs use different comparison methods. In this way, the resultant concentration level can fully exploit the involved features by being specifically directed to such features.

Since different feature pairs differ in their respective characteristics or properties, the method (represented by function fᵢ) used for comparing any feature pair can be selected based on the specifics of the features, in order to produce a more reliable estimate of concentration level based on the correlation between the features in each feature pair. For example, if the viewer's emotion and eye movement are selected as two viewer status features, then different methods may be used for comparing the emotion and eye movement with their corresponding content characteristics in order to establish correlations between the viewer's status and content characteristics.

Thus, one method may be used to compare the viewer's emotion (e.g., facial expressions or other responses detected by sensors) with the specific story line or plot in the content. A different method may be used to compare the viewer's eye movement with a specific object in the content. Furthermore, in devising such a method, other practical factors may need to be taken into consideration. For example, a viewer's eye may not be focused 100% of the time on the main subject in a scene. So the method may need to take into account such factors in comparing or correlating the viewer's eye movement with the specific content characteristic feature, in order to provide a more reliable estimate for the concentration level.

The system 200 may also omit certain elements, include other elements (not shown), as well as other variations that are contemplated by one of ordinary skill in the art given the teachings of the present principles provided herein.

FIG. 3 shows an exemplary method 300 for determining a concentration level of a viewer of displayed video content, by modeling an extent to which the viewer is engaged by and/or otherwise interested in currently displayed video content, in accordance with an embodiment of the present principles.

At step 310, at least one feature that represents a viewer status with respect to the currently displayed video content, e.g., sᵢ(t), is extracted (for example, by the view status detector 210).

At step 320, at least one feature that represents a content characteristic with respect to the currently displayed video content, e.g., vᵢ(t), is extracted (for example, by the content analyzer 220).

At step 330, at least one viewer status feature and at least one content characteristic features are compared as a feature pair by the feature comparer 230 using a method suitable for the specific feature pair to provide an estimate of a concentration level cᵢ(t)=fᵢ(sᵢ(t), vᵢ(t)) associated with the feature pair: sᵢ(t) and vᵢ(t). It is to be appreciated that step 330 may involve selecting a particular comparison method (i.e., function represented by fᵢ) from among multiple comparison methods, responsive to or according to the particular features to be compared.

At step 340, the concentration level estimates for different feature pairs are combined by the combiner 240 into an overall, more accurate estimate of the concentration level, when more than one feature pair is selected.

A description will now be given regarding the problem of how well a viewer is following currently displayed content.

Before video content association (VCA), it was essential to measure information such as whether or not the viewer was interested in the currently displayed content (hereinafter also “current content”) and to what extent. Without the guidance of such information, VCA is essentially blindly applied, and will hardly improve the viewing experience. Such blindly applied VCA operations include, but are not limited to, advertisement insertion when the viewer is fully engaged by the current content, additional materials association when the viewer is not at all interested in the current content, and so forth.

To avoid blindly applying VCA operations, a model is constructed according to one embodiment of the present principles, hereinafter referred to as the “concentration model” to establish how much the viewer is engaged by and/or otherwise interested in the current content. More specifically, the concentration model allows a concentration level to be obtained, which is given by a degree of correlation between the features related to the viewer status and the content characteristic at a given time. For example, a higher correlation determined between the two features means that the viewer has a higher concentration level for the content being displayed.

In one embodiment, the input to the concentration model includes the currently displayed content and the status of the viewer. As an example, the output of the concentration model can be represented by a value between 0 and 1 indicating the level (hereinafter referred to as the “concentration level”) that the viewer is engaged by and/or otherwise interested in the content, where 0 means the viewer is totally not engaged by and/or otherwise not at all interested in the content, while 1 means the viewer is very engaged by and/or otherwise very interested in the content. Of course, the selection of a range from 0 to 1 is merely illustrative and other values or ranges can also be used.

A description will now be given regarding the concentration model, in accordance with an embodiment of the present principles.

V(t), S(t) respectively denote the current displayed content and the status of the viewer at time t (0≦t≦T), and C(t) denotes the concentration level of the viewer at time t, and T represents the time duration or period during which the viewer status is being monitored with respect to the displayed content. The concentration model is then used to estimate the concentration level given the current displayed content and the status of the viewer as follows:

C(t)=F(V(t),S(t)) Eq. (1)

F(•) is a function to compare the video content and viewer status features and determine the correlation between the video content and the viewer status. Since the video content and the viewer status cannot be directly compared, features from both the video content and the viewer status are extracted, and compared to obtain a final score as the “concentration level”.

(v₁(t), v₂(t), vₘ(t))^{T} and (s₁(t), s₂(t), sₘ(t))^{T} respectively denote feature vectors extracted from the video content and the viewer status. The dimension m indicates the number of extracted features, and the superscript “T” denotes the transpose of the respective matrices.

In some embodiments, the features in a feature pair can be extracted or selected according to any one or more of the following rules:

(1) vᵢ(t) and sᵢ(t) have comparable physical meaning, or have a certain relationship to each other so that there is an expected correlation between the two features. For example, a viewer's visual attention and an object's action in a scene will be a reasonable feature pair, because of the relationship between visual attention and action in the scene. However, the viewer's visual attention and the speech of the content may not be as good a choice for a feature pair, because of the lack of relationship between visual attention and speech.
(2) at least two different video content or content characteristic features, i.e., vᵢ(t) and vⱼ(t), with i≠j, are selected for comparing with respective viewer status features to provide at least two estimates of the concentration level for the two feature pairs.
(3) if more than one content characteristic features are selected for determining the concentration level, each content feature is used in only one comparison. In other words, vᵢ(t) and vⱼ(t) are independent of each other if i≠j.

As an example, select vᵢ(t) as the viewer emotion extracted by sensors and sᵢ(t) as the estimated emotional factor of the content. It can be seen that such defined two features are comparable or related to each other.

For each comparable or related feature pair vᵢ(t) and sᵢ(t), a function fᵢ(.,.) can be defined such that cᵢ(t)=fᵢ(vᵢ(t), sᵢ(t)) reveals or provides the concentration level associated with the specific feature pair. In one example, a logistic function can be used as fᵢ(.,.).

It is to be noted that the feature pair vᵢ(t′) and sᵢ(t′) with t′<t can also be used in the estimate of fᵢ(vᵢ(t), sᵢ(t)). In other words, data or feature pairs that have previously been extracted and/or stored (at times earlier than the current time) can also be used in estimating the concentration level.

Finally, the estimates of concentration level fᵢ(vᵢ(t), sᵢ(t)) for each feature pair are combined to produce a final estimate for the concentration level C(t) of viewer at time t.

C(t)=g(f₁(v₁(t),s₁(t),f₂(v₂(t),s₂(t)), . . . ,fₘ(vₘ(t),sₘ(t))) Eq. (2)

In Equation (2), g(•) is a proper selected combining function. A usually adopted function is weighted average, which results in the following:

$$C ( t ) = \frac{{\sum }_{i = 1}^{m} {w}_{i} \times {f}_{i} ( {v}_{i} ( t ) , {s}_{i} ( t ) )}{{\sum }_{i = 1}^{m} {w}_{i}} \qquad Eq . ( 3 )$$

where wᵢ refers to a weight assigned to the feature pair of content characteristic and viewer status denoted by subscript i.

Of course, it is to be appreciated that the present principles are not limited to the use of weighted average when combining concentration levels and, thus, other combining functions can also be used, while maintaining the spirit of the present principles.

A description will now be given regarding an implementation directed to emotion, in accordance with an embodiment of the present principles.

With more selected feature pairs, the estimated concentration level will be more accurate. However, different feature pairs have quite different characteristics and thus can involve totally different feature comparing methods.

As an example, a single feature pair is used, i.e., m=1, to explain the concentration model framework. The single feature pair selected relates to emotion.

The feature v₁(t) extracted from the viewer status is viewer emotion at time t, the feature s₁(t) extracted from the content is content emotion at time t. For illustrative purposes, emotion types are classified into the following five categories: no emotion; joy; anger; sadness; and pleasure. Thus, the values of v₁(t) and s₁(t) are a respective one of the values of {no emotion, joy, anger, sadness, pleasure}.

For the extraction of viewer emotion, data can be gathered using the following four sensors: a triode electromyogram (EMG) measuring facial muscle tension along the masseter; a photoplethysmyograph measuring blood volume pressure (BVP) placed on the tip of the ring finger of the left hand; a skin conductance sensor measuring electrodermal activity (SEA) from the middle of the three segments of the index and middle fingers on the palm-side of the left hand; and a Hall effect respiration (RSP) sensor placed around the diaphragm. It is to be appreciated that the preceding selection of sensors is merely for illustrative purposes and other sensors can also be used in accordance with the teachings of the present principles.

There is already research work on emotion estimation based on the preceding types of sensory data. The nearest neighbor algorithm is adopted in this example, and for simplicity, denoted as h₁. Thus, the emotion associated with the content displayed at time t is given by the following:

v₁(t)=h₁(E(t),B(t),S(t),R(t)) Eq. (4)

In Equation (4), E(t), B(t), S(t), and R(t) are EMG, BVP, SEA, and RSP sensory data, respectively.

There is also research work on video classifiers. With these results, a scenario of the video content can be classified, for example, into different emotions such as joy, sadness, and so on, and the emotion s₁(t) of the content can be extracted.

Feature comparing is then adopted on a scenario basis. The viewer emotion during a scenario is set to the primary emotion experienced by the viewer during this scenario period. That is, the feature of viewer emotion is extracted by selecting a primary indicator of the feature over other (less prominent) indicators of the feature. In this case, the primary indicator is considered representative of the primary emotion.

For this example, the comparing between viewer emotion and content emotion is executed by the empirical look-up table shown as TABLE 1.

TABLE 1

| | Viewer emotion | | | | |
|---|---|---|---|---|---|
| content emotion | no emotion | joy | anger | sadness | pleasure |
| no emotion | 1.0 | 0.25 | 0.25 | 0.25 | 0.25 |
| joy | 0.25 | 1.0 | 0 | 0 | 0.75 |
| anger | 0.25 | 0 | 1.0 | 0.25 | 0 |
| sadness | 0.25 | 0 | 0.25 | 1.0 | 0 |
| pleasure | 0.25 | 0.75 | 0 | 0 | 1.0 |

The average value among all scenarios provides the concentration level. It is to be appreciated that the values shown in TABLE 1 are for illustrative purposes and, thus, other values for the same items can also be used, while maintaining the spirit of the present principles.

A description will now be given regarding other exemplary implementations (applications) to which the present principles can be applied, in accordance with an embodiment of the present principles.

In a first example, suppose that a currently displayed image depicts a dog in a grassland. The human eye gaze can be selected as a feature of the viewer status, and the region of interest (the “dog” in this example) can be selected as a corresponding feature of the content characteristic. Thus, in comparing a viewer status feature to a content characteristic feature, as in step 330 of FIG. 3, a determination is made as to whether the human eye gaze is around the region of interest (i.e., the “dog”). If so, one can conclude that the viewer is concentrating on the currently displayed content. Otherwise, it can be concluded that the viewer is not concentrating on the currently displayed content. It is to be appreciated that the preceding example can be modified to use thresholds. For example, regarding checking the human eye gaze around the region of interest, the determination can implemented with respect to a time interval or a percentage (e.g., 80%) of a time interval, such that if the gaze is around the region of interest at least 80% of the time, then the viewer would be considered as concentrating on the content. Given the teachings of the present principles provided herein, one of ordinary skill in the art will contemplate these and other variations of the present principles, while maintaining the spirit of the present principles.

In another example, suppose the currently displayed video is a football match. One can select, as one feature of the viewer status, the heartbeat rate curve along a given time interval, and can select a corresponding feature of the content characteristic as the highlight (“goal”, and so forth) curve along the given time interval. Thus, to compare a viewer status feature to a content characteristic feature, as in step 330 of FIG. 3, a determination can be made to see if the heartbeat rate curve is following the highlights of the football match. If so, one can conclude that the viewer is concentrating on the currently displayed content. Otherwise, one can conclude that the viewer is not concentrating on the currently displayed content.

The functions of the various elements shown in the figures may be provided through the use of dedicated hardware as well as hardware capable of executing software in association with appropriate software. When provided by a processor, the functions may be provided by one or more processors, any one or some of which may be dedicated or shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A system for determining concentration level of a viewer of displayed video content, comprising:
a view status detector for extracting at least one feature that represents a viewer status with respect to the displayed video content;
a content analyzer for extracting at least one feature that represents a content characteristic of the displayed video content;
a feature comparer for comparing the viewer status and the content characteristic features as a feature pair, to provide an estimate of a concentration level for the feature pair; and
a combiner for combining concentration level estimates for different feature pairs into an overall concentration level.

2. The system of claim 1, wherein the feature comparer is configured to select a particular comparison method for a respective one of the different feature pairs according to the features in the respective one of the different feature pairs, such that at least two different ones of the different feature pairs use different comparison methods.

3. The system of claim 1, wherein the viewer status and content characteristic features are selected for extraction based on a relationship between the two features.

4. The system of claim 1, wherein at least one of the viewer status and content characteristic features is extracted using at least one sensor.

5. The system of claim 4, wherein the at least one sensor comprises a triode electromyogram, a photoplethysmyograph, a skin conductance sensor, and a Hall effect respiration sensor.

6. The system of claim 1, wherein the viewer status feature represents a viewer emotion and the content characteristic feature represents an emotion associated with the displayed content.

7. The system of claim 1, wherein the particular comparison method comprises applying a logistic function to the viewer status and content characteristic features.

8. The system of claim 1, wherein said combiner combines the concentration levels for different feature pairs into the overall concentration level using a weighted average function.

9. The system of claim 1, wherein the viewer status and content characteristic features correspond to a common time instant or common time interval.

10. The system of claim 1, wherein at least one of the viewer status and content characteristic features are extracted by selecting a primary indicator of the feature over other indicators of the feature.

11. The system of claim 1, wherein the viewer status and content characteristic features are mapped to a common scale used by the particular comparison method.

12. A method for determining concentration level of a viewer of displayed video content, comprising:
extracting at least one feature that represents a viewer status with respect to the displayed video content;
extracting at least one feature that represents a content characteristic of the displayed video content;
comparing the viewer status and content characteristic features as a feature pair, to provide an estimate of a concentration level for the feature pair; and
combining concentration level estimates for different feature pairs into an overall concentration level.

13. The method of claim 12, wherein the comparing is performed using a particular comparison method for a respective one of the different feature pairs, and the particular method is selected according to the features in the respective one of the different feature pairs, such that at least two different ones of the different feature pairs use different comparison methods.

14. The method of claim 12, wherein the viewer status and content characteristic features are selected for extraction based on a relationship between the two features.

15. The method of claim 12, wherein at least one of the viewer status and content characteristic features are extracted using at least one sensor.

16. The method of claim 15, wherein the at least one sensor comprises a triode electromyogram, a photoplethysmyograph, a skin conductance sensor, and a Hall effect respiration sensor.

17. The method of claim 12, wherein the viewer status feature represents a viewer emotion and the content characteristic feature represents an emotion associated with displayed content.

18. The method of claim 12, wherein the particular comparison method comprises applying a logistic function to the viewer status and content characteristic features.

19. The method of claim 12, wherein said combining step combines the concentration levels for different feature pairs into the overall concentration level using a weighted average function.

20. The method of claim 12, wherein the viewer status and content characteristic features correspond to a common time instant or common time interval.

21. The method of claim 12, wherein at least one of the viewer status and content characteristic features is extracted by selecting a primary indicator of the feature over other indicators of the feature.

22. The system of claim 12, wherein the viewer status and content characteristic features are mapped to a common scale used by the particular comparison method.

23. A computer readable storage medium comprising a computer readable program for determining concentration level of a viewer of displayed video content, wherein the computer readable program when executed on a computer causes the computer to perform the following steps:
extracting at least one feature that represents a viewer status with respect to the displayed video content;
extracting at least one feature that represents a content characteristic of the displayed video content;
comparing the viewer status and content characteristic features as a feature pair using a particular comparison method, to provide an estimate of a concentration level for the feature pair; and
combining concentration level estimates for different feature pairs into an overall concentration level.
